(19) United States
(12) Patent Application Publication
(10) Pub. No.: US 2017/0075816 A1
(43) Pub. Date: Mar. 16, 2017

(54) STORAGE SYSTEM

(71) Applicant: HITACHI, LTD., Tokyo (JP)

(72) Inventors: Naoya OKADA, Tokyo (JP); Masanori TAKADA, Tokyo (JP); Shintaro KUDO, Tokyo (JP); Yusuke NONAKA, Tokyo (JP); Tadashi TAKEUCHI, Tokyo (JP)

(73) Assignee: HITACHI, LTD., Tokyo (JP)

(21) Appl. No.: 15/125,313

(22) PCT Filed: Apr. 24, 2014
(86) PCT No.: PCT/JP2014/061523

§ 371 Date: Sep. 12, 2016

(51) Int. Cl. G06F 12/1009; G06F 3/06; G06F 13/16; G06F 12/109

(52) U.S. Cl. CPC G06F 12/1009; G06F 12/109; G06F 3/0619; G06F 3/0647; G06F 3/0683; G06F 13/1668

(57) ABSTRACT

A control apparatus, in a storage system, accesses a specific storage area in a shared memory by designating a fixed virtual address, even when a capacity of the shared memory in the storage system changes. A space of a physical address indicating a storage area in a plurality of memories in a self-control-subsystem of two control-subsystems and a space of a physical address indicating a storage area in the plurality of memories in the other-control-subsystem are associated with a space of a virtual address used by each of a processor and an input/output device in the self-control-subsystem. Upon receiving data transferred from the other-control-subsystem to the self-control-subsystem, a relay device translates a virtual address indicating a transfer destination of the data designated by the other-control-subsystem into a virtual address in the self-control-subsystem based on an offset determined in advance, and transfers the data to the translated virtual address.

### TECHNICAL FIELD

This invention relates to a storage system.

### BACKGROUND ART

A storage system is known that has the following configuration to improve availability. Specifically, two controllers are provided and each controller includes a shared memory. Each controller can access the shared memory of the other controller through connection between the controllers. Thus, data can be duplicated to be stored in the shared memories of the two controllers.

In this context, PTL 1 discloses a configuration in which a plurality of nodes are coupled to a switch through an NTB (Non-Transparent Bridge), and the switch calculates and transmits an address translation amount to be configured in the NTB.

A storage system is known that has the following configuration to improve performance. Specifically, a controller includes two processors coupled to each other and shared memories coupled to the respective processors. Each processor can access the shared memory of the other processor through connection between the processors.

In this context, AMP (Asymmetric Multiprocessing) as an architecture in which a plurality of processors execute asymmetrical processes is known. In this architecture, all the processors process data with the same virtual address. Thus, the virtual address is converted into a physical address, and access is made to the physical address of the shared memory. In this case, storage areas of two shared memories, coupled to the two respective processors are arranged to be evenly accessed in physical address spaces of the shared memories. Thus, the two processors can make an access without taking the physical positions of the two shared memories into account. However, the performance is degraded by a large amount of communications between the processors.

NUMA (Non-Uniform Memory Access) is known, which is an architecture in which a plurality of processors access a shared memory at different speeds.

In this context, PTL 2 discloses a technique of allocating an identification number for identifying a position of a node to each node in a NUMA system, and determining an efficient access method based on the identification number.

### CITATION LIST

### Patent Literature

### [PTL 1]

International Publication No. WO 2012/157103

### [PTL 2]

U.S. Pat. No. 7,996,433

### SUMMARY OF INVENTION

### Technical Problem

The capacity of the shared memory might change. This happens in such cases where one of the two redundant controllers for achieving high availability is stopped and the shared memory in the controller is expanded to increase the data amount for caching data transferred from a host computer. In such a case, a physical address space in one of the controllers changes and one controller does not have information on the physical address space of the other controller. Thus, when one controller accesses the shared memory of the other controller, the access might fail or data in the shared memory might be destroyed. To prevent this from happening, an administrator of the storage system needs to reconfigure information on address translation between the controllers in accordance with the change in the capacity of the shared memory.

When a controller includes a plurality of processors, a capacity of a shared memory coupled to one of the processors might change. In such a case, when a certain processor accesses the shared memory coupled to the other processor in the controller, the access might fail or data in the shared memory might be destroyed. To prevent this from happening, an administrator of the storage system needs to reconfigure information on address translation in the controller in accordance with the change in the capacity of the shared memory.

An operation to reflect such change in the capacity of the shared memory on the information on the address translation is extremely cumbersome and expensive.

### Solution to Problem

To solve the problem described above, a storage system according to an aspect of the present invention includes a storage device, and a control system coupled to the storage device. The control system includes two control-subsystems coupled to each other. Each of the two control-subsystems includes a plurality of control apparatuses coupled to each other, and a plurality of memories coupled to the plurality of control apparatuses respectively. Each of the plurality of control apparatuses includes a processor, and an input/output device coupled to the processor. The input/output device includes a relay device coupled to the control apparatus in an other-control-subsystem of the two control-subsystems. A space of a physical address indicating a storage area in the plurality of memories in a self-control-subsystem of the two control-subsystems and a space of a physical address indicating a storage area in the plurality of memories in the other-control-subsystem are associated with a space of a virtual address used by each of a processor and an input/output device in the self-control-subsystem. Upon receiving data transferred from the other-control-subsystem to the self-control-subsystem, the relay device converts a virtual address indicating a transfer destination of the data designated by the other-control-subsystem into a virtual address in the self-control-subsystem based on an offset determined in advance, and transfers the data to the converted virtual address.

### Advantageous Effects of Invention

In an aspect of this invention, a control apparatus in a storage system can access a specific storage area in a shared memory by designating a fixed virtual address, even when a capacity of the shared memory in the storage system changes.

### BRIEF DESCRIPTION OF DRAWINGS

FIG. 1 shows a configuration of a computer system according to an embodiment.

FIG. 2 shows a configuration of a physical address space.

FIG. 3 shows relationship among the physical address space, a core virtual address space, and an IO virtual address space.

FIG. 4 shows a core translation table.

FIG. 5 shows an IO translation table.

FIG. 6 shows relationship among address spaces of clusters.

FIG. 7 shows hardware configuration information.

FIG. 8 shows a physical address table.

FIG. 9 shows processing of starting a cluster 110.

FIG. 10 shows core translation table generation processing.

FIG. 11 shows IO translation table generation processing.

FIG. 12 shows parameters in a host I/F transfer command.

FIG. 13 shows parameters in a DMA transfer command.

FIG. 14 shows parameters in a PCIe data transfer packet.

FIG. 15 shows host I/F write processing.

FIG. 16 shows DNA write processing.

FIG. 17 shows relationship among address spaces of clusters in Embodiment 2.

FIG. 18 shows a core extension translation table of Embodiment 2.

FIG. 19 shows an extended virtual address table.

FIG. 20 shows core translation table generation processing in Embodiment 2.

FIG. 21 shows IO translation table generation processing in Embodiment 3.

### DESCRIPTION OF EMBODIMENTS

Information in this invention, described below with expressions such as “aaa table”, “aaa list”, “aaa DB”, and “aaa queue”, may be expressed with a data structure other than a table, a list, a DB, a queue, or the like. Thus, the “aaa table”, “aaa list”, “aaa DB”, “aaa queue”, and the like may be referred to as “aaa information” to show that the information does not depend on the data structures.

Contents of pieces of information are described with expressions such as “identification information”, “identifier”, “title”, “name”, and “ID” that may be replaced with one another.

The following description may be Given with “program” as a subject. The program is predetermined processing executed by a processor by using a memory and a communication port (communication control device), and thus a description may be given with the processor as a subject. The processing disclosed with the program as the subject may be processing executed by a computer and an information processing device such as a storage controller. At least part of the program may be implemented by dedicated hardware.

Various programs may be installed in each computer with a program distribution server or a computer-readable memory medium. In such a case the program distribution server includes a processor (for example a CPU: Central Processing Unit) and a memory resource. The memory resource stores a distribution program and a program as a target of distribution. When the CPU executes the distribution program, the CPU of a program distribution server distributes the target program to other computers.

Embodiments of this invention are described with reference to the drawings.

### Embodiment 1

A configuration of a computer system according to an embodiment is described below.

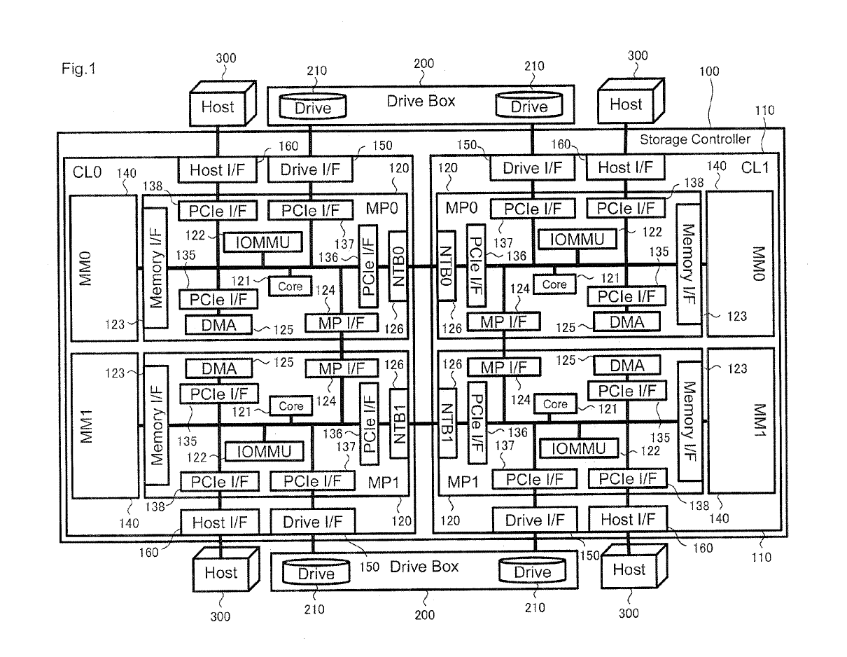

FIG. 1 shows the configuration of the computer system according to the embodiment.

The computer system includes one storage controller 100, two drive boxes 200, and four host computers 300. The drive box 200 includes two drives 210. The drive box 200 is coupled to a storage controller 100, and is a non-volatile semiconductor memory, a hard disk drive (HDD), or the like. The host computer 300 is coupled to the storage controller 100, and accesses data in the drives 210 through the storage controller 100.

The storage controller 100 includes two clusters (CLs) 110 having the same configuration. The two clusters 110 are referred to as a CL0 and a CL1 to be distinguished from each other. Each of the clusters 110 includes two sets of an MP (microprocessor package) 120, an MM (memory) 140, a drive I/F (interface) 150, and a host I/F 160. The two MPs 120 in one cluster 110 are referred to as an MP0 and an MP1 to be distinguished from each other. The two memories 140 in one cluster 110 are referred to as an MM0 and an MM1 to be distinguished from each other. The MM0 and the MM1 are respectively coupled to the MP0 and the MP1. The memory 140 is a dynamic random access memory (DRAM) for example. The memory 140 stores a program and data used by the MP 120.

The CL0 and the CL1, which have the same configuration in this embodiment, may have different configurations. A capacity of the memory 140 in the CL0 and a capacity of the memory 140 in the CL1 may be different from each other.

The MP 120 includes a core 121, an IOMMU (Input/Output Memory Management Unit) 122, a memory I/F 123, an MP I/F 124, a DMA (DMAC: Direct Memory Access Controller) 125, an NTB 126, and PCIe (PCI Express: Peripheral Component Interconnect Express) I/Fs 135, 136, 137, and 138. The core 121, the IOMMU 122, the memory I/F 123, the MP I/F 124, and the PCIe I/Fs 135, 136, 137, and 138 are coupled to each other through an IO bus in the MP. The two NTBs 126 in the MP0 and the MP1 in one cluster 110 are respectively referred to as an NTB0 and an NTB1 to be distinguished from each other. A device coupled to a PCIe bus may be referred to as an IO device. The IO device includes the DMA 125, the NTB 126, the drive I/F 150, the host I/F 160, and the like. Each of the PCIe I/Fs 135, 136, 137, and 138 is provided with a PCIe port ID.

The core 121 controls the storage controller 100 based on a program and data stored in the memory 140. The program may be stored in a computer-readable storage medium, and the core 121 may read out the program from the storage medium. The core 121 may be a core of a microprocessor such as a CPU, or may be a microprocessor itself.

The memory I/F 123 is coupled to the memory 140 corresponding to a self-MP.

The MP I/F 124 is coupled to the MP I/F of an other-MP in a self-cluster, and controls communications between the self-MP and the other-MP.

The DMA 125 is coupled to an IO bus through a PCIe bus and a PCIe I/F 135, and controls communications between the memory 140 of the self-MP and an IO device or the memory 140 of the other-MP.

The NTB 126 is coupled to the IO bus through the PCIe bus and the PCIe I/F 136, coupled to the NTB 126 of the corresponding MP 120 in an other-cluster through the PCIe bus, and controls communications between the self-cluster and the other-cluster.

The PCIe I/F 137 is coupled to the drive I/F 150 corresponding to the self-MP through the PCIe bus. The PCIe I/F 138 is coupled to the host I/F 160 corresponding to the self-MP through the PCIe bus.

When the IO device accesses the memory 140, the PCIe I/F coupled to the IO device converts a virtual address used by the IO device into a physical address by using the IOMMU 122, and the access is made to the physical address.

The drive I/F 150 is coupled to the corresponding drive 210. The host I/F 160 is coupled to the corresponding host computer 300.

Terms for describing this invention are described. A storage system corresponds to the storage controller 100, the drive box 200, and the like. A storage device corresponds to the drive 210 and the like. A control system corresponds to the storage controller 100 and the like. A control-subsystem corresponds to the cluster 110 and the like. A control apparatus corresponds to the MP 120 and the like. A memory corresponds to the memory 140 and the like. A processor corresponds to the core 121 and the like. An input/output device corresponds to the IO device (DMA 125, NTB 126, drive I/F 150, and host I/F 160), the PCIe I/F (135, 136, 137, and 138) coupled to the same, and the like. A relay device corresponds to the NTB 126, the PCIe I/F 136 coupled to the same, and the like. A memory translation device corresponds to the IOMMU 122 and the like.

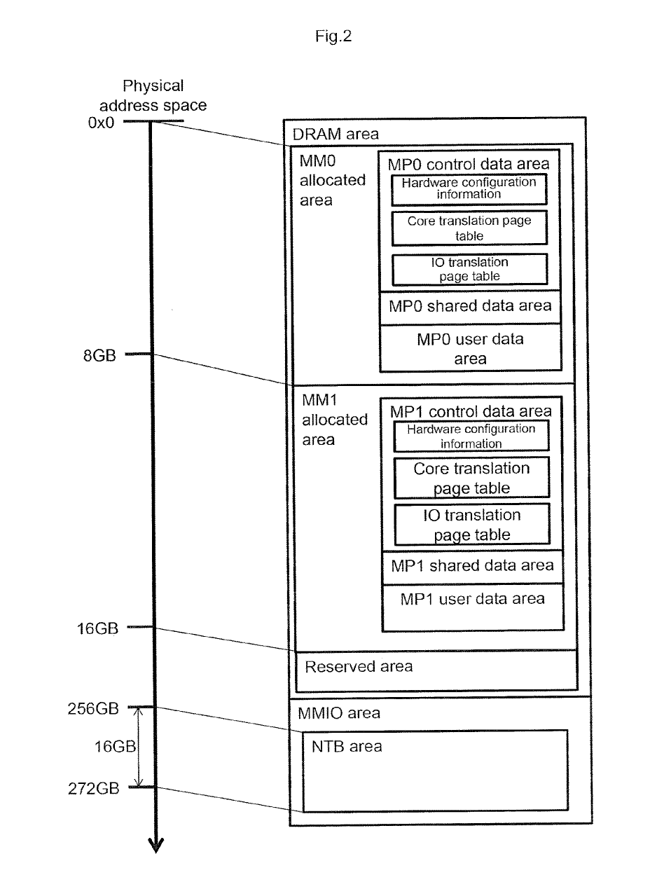

FIG. 2 shows a configuration of a physical address space.

In the physical address space indicating the physical address of a storage area in the memory 140, a DRAM area, a reserved area, and an MNIO (Memory Mapped Input/Output) area are serially arranged in this order from the start.

In the DRAM area, storage areas in the two memories 140 in the self-cluster are serially arranged. In the DRAM area, an MM0 allocated area and an MM1 allocated area are serially arranged in this order from the start based on PUMA. The MM0 allocated area is allocated with a storage area of the MM0 in the self-cluster. The MM1 allocated area is allocated with a storage area of the MM1 in the self-cluster.

In the allocated area corresponding to one MP 120 and one memory 140, a control data area, a shared data area, and a user data area are serially arranged. The control data area stores control data including a program code as a program that can be executed by the core 121 of the self-MP. The core 121 of the self-MP can access the control data area but the core 121 not in the self-MP and the IO devices cannot access the control data area. The shared data area stores shared data as information that can be read and written by a plurality of cores 121 in the self-MP. All the cores 121 in the storage controller 100 can access the shared data area but the IO devices cannot access the shared data area. The user data area stores user data transferred from the host computer 300 managed by the self-MP. All the cores 121 and the IO devices in the storage controller 100 can access the user data area. The control data area stores: hardware configuration information indicating a configuration of the self-cluster; a core translation table used by each of the cores 121 to translate the virtual address; and an IO translation table used by the IOMMU 122 to translate the virtual address. The control data area may further include a physical address table. The control data area may store a base table, as a base of the core translation table and the IO translation table, in advance. These pieces of data are described later. Pointers of these pieces of data may be configured in a register of the core 121, and the core 121 may read these pieces of data.

In the figure, the control data area, the shared data area and the user data area are provided with identifiers of the corresponding MPs 120 to be distinguished from each other. In the MM0 allocated area, an MP0 control data area, an NP0 shared data area, and an MP0 user data area are serially arranged in this order from the start. In the MM1 allocated area, an MP1 control data area, an MP1 shared data area, and an MP1 user data area are serially arranged in this order from the start.

The reserved area is a storage area that cannot be accessed.

The MMIO area starts at a predetermined MMIO start address that is after the MM1 allocated area. The MMIO start address is sufficiently larger than a size of the DRAM area. In this example, the size of the DRAM area is 16 GB, and the MMIO start address is at a position of the 256 GB from the start. The MMIO area includes an NTB area. DRAM areas of the other clusters are mapped in the NTB area. Here, the capacity of the memory 140 of the self-cluster is assumed to be the same as the capacity of the memory 140 of the other-cluster. Here, the size of the NTB area is the same as the size of the DRAM area. Arrangement of areas in the DRAM area in the physical address space of the other-cluster is the same as the arrangement of areas in the DRAM area in the physical address space of the self-cluster. In other words, the arrangement of the NTB area is obtained by adding an offset of the MMIO start address to the DRAM area in the physical address space of the other-cluster.

In the physical address space, the areas are arranged as one MM0 allocated area, and the areas are arranged as one MM1 allocated area. Thus, the amount of communications between the MPs can be reduced and thus the performance of the storage controller 100 can be improved, compared with a case of the physical address space that make two memories evenly accessed. In the physical address space, the control data area, the shared data area, and the user data area are arranged in the area of one memory 140. Thus, storage areas with the access rights varying among devices can be arranged.

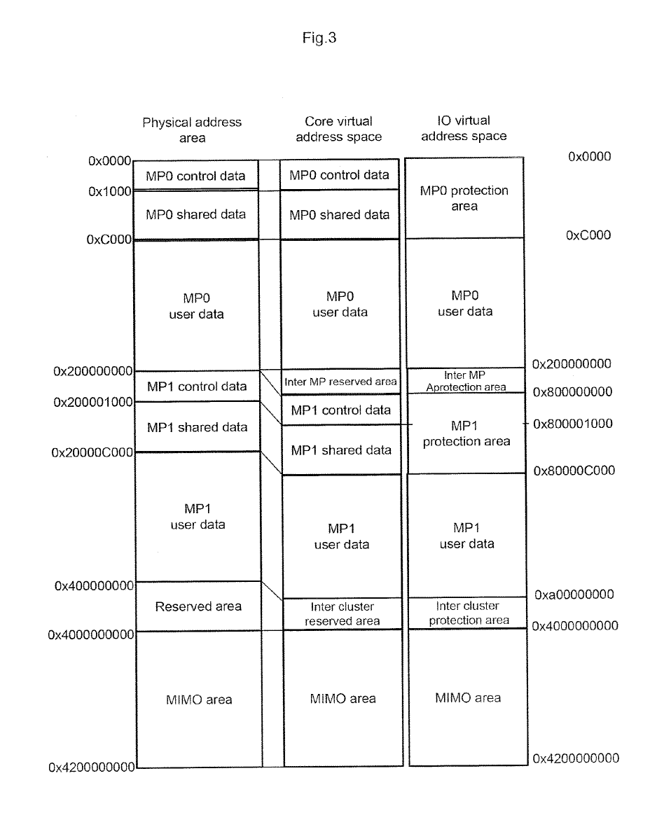

FIG. 3 shows relationship among the physical address space, the core virtual address space, and the IC virtual address space.

The core 121 generates a core translation table indicating association between virtual addresses and physical addresses for the core 121, and stores the core translation table in the memory 140. A command to the core 121 designates a target storage area in the memory 140 with a virtual address. The command is stored as a program in the memory 140, for example. The core 121 translates the designated virtual address into a physical address based on the core translation table, and accesses the physical address. A space of the virtual address designated with the core 121 is referred to as a core virtual address space.

The core 121 generates an IC translation table indicating association between virtual addresses and physical addresses for the IC devices, and stores the IO translation table in the memory 140. A command to an IO device designates a target storage area in the memory 140 with a virtual address. When the IO device accesses the memory 140, the IOMMU 122 translates the designated virtual address into a physical address by using the IO translation table. A space of the virtual address designated with the IO device is referred to as an IO virtual address space.

In the core virtual address space, an MP0 control data area, an MP0 shared data area, an NP0 user data area, an inter MP reserved area, an MP1 control data area, an MP1 shared data area, an MP1 user data area, an inter cluster reserved area, and an MMIO area are serially arranged in this order from the start. Data stored in the MP0 control data area, the NP0 shared data area, the NP0 user data area, the MP1 control data area, the MP1 shared data area, the MP1 user data area, and the MNIO area of the areas is the same as that in the physical address space. The various reserved areas may be hereinafter simply referred to as a reserved area. The reserved area may be allocated as the DRAM area, in response to change in the capacity of the memory 140 due to expansion of the memory 140, and the like. Alternatively, the reserved area may be used as a storage area to which the IO devices and the core 121 cannot access, when a user intends to avoid the access to the memory by the IO devices and the core 121.

In this embodiment, in the virtual address space, the data areas with fixed capacities such as the control data area and the shared data area are followed by data areas with variable capacities such as the user data area. In the virtual address space, a storage area (referred to as a reserved area or a margin) that is not mapped in the physical address space, for example, and thus cannot be used for the memory access is arranged after an end address of the variable capacity data area, and then a data area of a different type is arranged. With such an arrangement, the mapping of the data areas with the fixed capacities in the address space needs not to be changed, and only the mapping related to the end address of the variable capacity data area is changed, when the capacity changes.

When the data area of the next type is arranged after the margin provided at least after the end address of the variable capacity data area, an effect that the load imposed when the mapping is changed can be reduced even when the data areas are arranged in an order different from that in the embodiment described above, can be obtained.

An address range of the MM0 allocated area (the MP0 control data area, the MP0 shared data area, and the MP0 user data area) in the core virtual address space is the same as an address range in the physical address space.

A start address of the MM1 allocated area (the MP1 control data area, the MP1 shared data area, and the MP1 user data area) in the core virtual address space is larger than a start address in the physical address space, and is configured to a predetermined MP1 start address. The maximum value of the end address of the MP0 user data area is the maximum capacity of the memory 140 allocated to the MP0. The MP 120 needs to recognize the MM0 and the MM1, and thus the maximum capacity of the memory 140 allocated to the MP0 is half the largest memory capacity recognizable by the MP 120. Thus, the MP1 start address is larger than the maximum value of the end address of the MP0 user data area. In this example, the size of the end address of the MP0 user data area is 8 GB, and the MP1 start address is at the position of the 32 GB from the start. Thus, the inter MP reserved area that cannot be accessed is arranged between the MM0 allocated area and the MM1 allocated area in the core virtual address space.

The start address of the MMIO area in the core virtual address space is an MMIO start address. Thus, in the MMIO area, the address range in the core virtual address space is the same as the address range in the physical address space. The MMIO start address is larger than the end address of the MP1 user data area in the core virtual address space. In this example, the end address of the MP1 user data area is at the position of the 16 GB from the start, and the MMIO start address is at the position of the 256 GB from the start. Thus, the inter cluster reserved area that cannot be accessed is arranged between the MP1 user data area and the MMIO area in the core virtual address space.

In the core virtual address space, the MMIO area of the self-cluster corresponds to the DRAM area of the other-cluster. The start address of each area in the DRAM area in the core virtual address space of the other-cluster is the same as the start address of each area in the DRAM area in the core virtual address space of the self-cluster. Thus, the core 121 in the self-cluster can access a specific storage area in the memory 140 in the other-cluster by using the fixed virtual address, even when the capacity of the memory 140 of the other-cluster changes.

An area as a sum of the control data area and the shared data area of a certain MP 120 may be hereinafter referred to as a system data area. The system data area can be accessed by the core in the self-cluster but cannot be accessed by the IO devices. The system data area of the MP0 is referred to as an MP0 system data area and the system data area of the MP1 is referred to as an MP1 system data area.

In the IO virtual address space, an MP0 protection area, an MP0 user data area, an inter MP protection area, an MP1 protection area, an MP1 user data area, an inter cluster protection area, and an MMIO area are serially arranged in this order from the start. The various protection areas may be hereinafter simply referred to as a protection area. The protection area is a storage area mapped in the physical address space with limitation on the memory access due to a memory access right configuration. With the protection area and the address space of the other cluster 110 mapped in the own address space by the cluster 110 for data transfer between the clusters 110, the cluster 110 side can control whether or not to receive data transferred from the other cluster 110. Thus, a memory access protection function can be provided even when the cluster 110 has no information on address space mapping of the other cluster 110.

An address range of the MP0 protection area in the IO virtual address space is the same as an address range of the MP0 system data area in the core virtual address space. The MP0 protection area cannot be accessed by the IO devices.

An address range of the MP0 user data area in the IO virtual address space is the same as an address range of that in the core virtual address space.

An address range of the inter MP protection area in the IO virtual address space is the same as an address range of the inter MP reserved area in the core virtual address space. The inter MP protection area cannot be accessed by the IO devices.

An address range of the MP1 protection area in the IO virtual address space is the same as an address range of the MP1 system data area in the core virtual address space. The MP1 protection area cannot be accessed by the IO devices.

An address range of the MP1 user data area in the IO virtual address space is the same as an address range of that in the core virtual address space.

The start address of the MMIO area in the IO virtual address space is the MMIO start address. Thus, the address range of the MMIO area in the IO virtual address space is the same as an address range of that in the core virtual address space. Thus, the address range of the inter cluster protection area in the IO virtual address space is the same as the address range of the inter cluster reserved area in the core virtual address space. The inter cluster protection area cannot be accessed by the IO devices.

As in the core virtual address space, the MMIO area of the self-cluster corresponds to the DRAM area of the other-cluster in the IO virtual address space. The start address of each area in the DRAM area in the IO virtual address space of the other-cluster is the same as the start address of each area in the DRAM area in the IO virtual address space of the self-cluster. Thus, the IO devices in the self-cluster can access a specific storage area in the memory 140 in the other-cluster by using the fixed virtual address, even when the capacity of the memory 140 of the other-cluster changes.

As described above, the MMIO start address is sufficiently large with respect to the size of the DRAM area. Thus, the self-cluster can access a specific storage area in the memory 140 of the other-cluster by using the fixed virtual address, regardless of the change in the capacity of the memory 140 of the self-cluster. The MM1 allocated area starts at the MP1 start address that is sufficiently large with respect to the size of the MM0 allocated area. Thus, the core 121 or the IO devices in the storage controller 100 can access a specific storage area in the MM1 by using the fixed virtual address, regardless of the change in the capacity of the memory 140. With the protection area provided in the IO virtual address space, the access from the IO devices to the MP0 system data area and the MP1 system data area can be prevented.

In the physical address space, the core virtual address space, and the IO virtual address space, the start address of the DRAM area may configured to a self-control-subsystem address determined in advance, and the start address of the MMIO area may be configured to an other-control-subsystem address determined in advance. In this embodiment, the self-control-subsystem address is at the start of the address space, and the other-control-subsystem address is the MMIO start address.

In the core virtual address space and the IO virtual address space, the start address of the MP0 system data area may be configured to a first system data address determined in advance, and the start address of the MP1 system data area may be configured to a second system data address determined in advance. In this embodiment, the second system data address is at the start of the address space, and the second system data address is the MP1 start address.

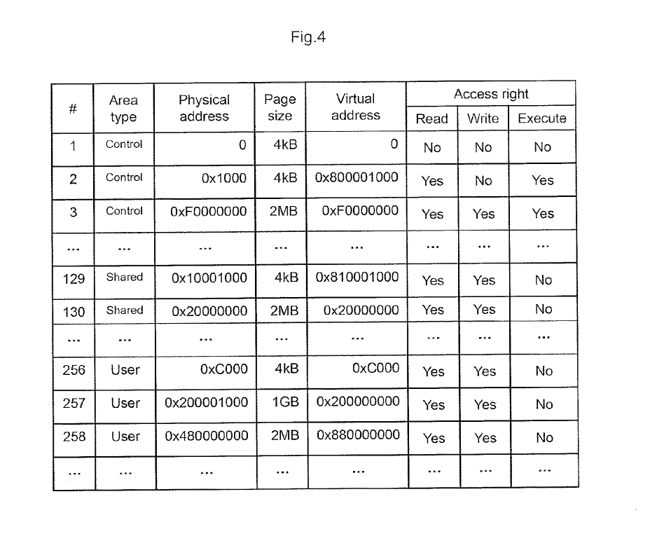

FIG. 4 shows the core translation table.

The storage controller 100 divides the storage area in the memory 140 into a plurality of pages and manages the pages. The core translation table is a page table including an entry for each page.

The entry of a page includes fields for a page number (#), an area type, a physical address, a page size, a virtual address, and access rights. The page number indicates an identifier of the page. The area type is the type of an area to which the page belongs. For example, the area type indicates any one of the control data area (control), the shared data area (shared), and the user data area (user). The physical address indicates the start address of the page in the physical address space. The page size indicates the size of the page. The virtual address indicates the start address of page in the core virtual address space. The access rights indicate the access rights of the core of the self-MP to the page, and includes Read access right, Write access right, and Execute access right. The Read access right indicates whether the Read access can be executed to the page. The Write access right indicates whether Write access to the page can be executed. Execute access right indicates whether the core 121 can process data stored in the page as a program executable code.

In the core translation table, the virtual address used by the core 121 is associated with the physical address. Thus, the core 121 can access a specific storage area by using the fixed virtual address, regardless of the change in the capacity of the memory 140. Even when the capacity of the memory 140 changes, the program including the command to the core 121 can be prevented from being changed.

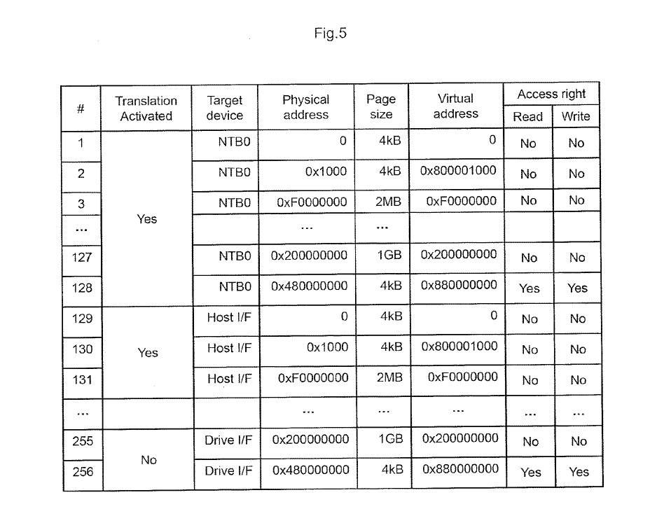

FIG. 5 shows an IO translation table.

The IO translation table is a page table and includes an entry for each page.

The entry of a page includes fields for a page number (#), a translation active flag, a target device, a physical address, a page size, a virtual address, and access rights. The page number indicates an identifier of the page. The translation active flag indicates whether the virtual address of the page is to be translated into a physical address. The target device indicates an identifier of the TO device that accesses the page. The physical address indicates the start address of the page in the physical address space. The page size indicates the size of the page. The virtual address indicates the start address of the page in the IO virtual address space. The access rights include a Read access right and a Write access right. The Read access right indicates whether Read access to the page can be executed. The Write access right indicates whether Write access to the page can be executed.

In the IO translation table, a plurality of IO devices may be associated with one physical address. In the IO translation table, a plurality of IO devices may be associated with one virtual address.

In the IO translation table, the physical address is associated with the virtual device used by each of the IO devices. Thus, the IO device can access a specific storage area by using the fixed virtual address regardless of the change in the capacity of the memory 140. The program including the command to the IO device can be prevented from being modified even when the capacity of the memory 140 changes.

In the core translation table and the IO translation table, the virtual address may be described as a virtual page number and the physical address may be described as a physical page number.

The core 121 generates the core translation table and the IO translation table based on the capacity of the memory 140 in the self-cluster. Thus, the fixed virtual address can be associated with a specific storage area even when the capacity of the memory 140 in the self-cluster changes.

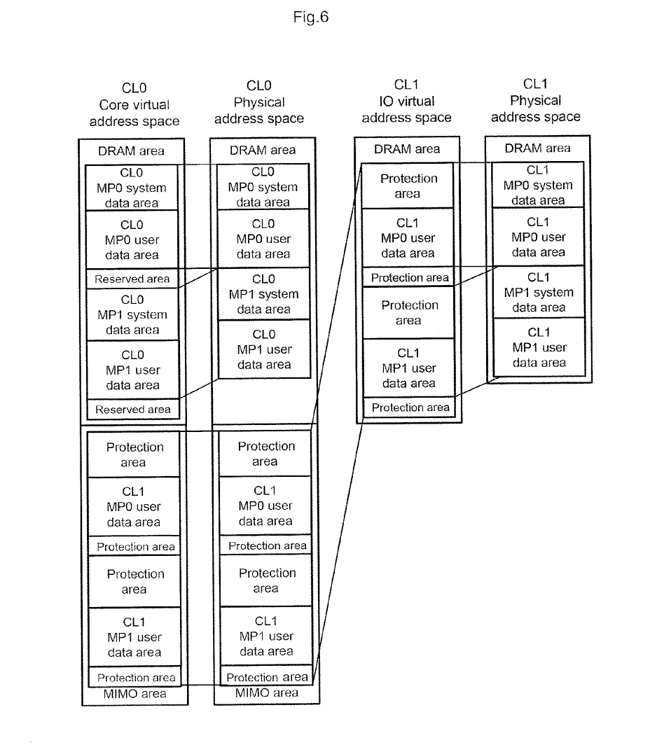

FIG. 6 shows relationship among address spaces of clusters.

The figure shows: a CL0 core virtual address space as a core virtual address space in the CL0 used by the core 121 in the CL0; a CL0 physical address space as a physical address space in the CL0; a CL1IO virtual address space as an IO virtual address space in the CL1 used by the core in the CL0 and the IO devices in the CL1; and a CL1 physical address space as a physical address space in the CL1. The capacities of the two memories 140 in the CL0 are assumed to be the same as the capacities of the two memories 140 in the CL1. The system and user data areas are each provided with an identifier of the corresponding cluster 110 and an identifier of the corresponding MP 120 to be distinguished from each other.

In the CL0 core virtual address space, the DRAM area and the MMIO area are serially arranged in this order from the start.

In the DRAM area of the CL0 core virtual address space, a CL0MP0 system data area, a CL0MP0 user data area, an inter CL0MP reserved area, a CL0MP1 system data area, a CL0MP1 user data area, and an inter cluster reserved area are serially arranged in this order from the start.

When the core 121 in the CL0 acquires a command designating a virtual address in the DRAM area, the core translates the designated virtual address into a physical address, and accesses the translated physical address.

In the CL0 physical address space, a CL0MP0 system data area, a CL0MP0 user data area, a CL0MP1 system data area, and a CL0MP1 user data area are serially arranged in this order from the start.

In the MMIO area of the CL0 core virtual address space, a CL1MP0 protection area, a CL1MP0 system data area, a CL1MP0 user data area, a CL1 inter MP protection area, a CL1MP1 protection area, a CL1MP1 system data area, a CL1MP1 user data area, and a CL1 inter cluster protection area are serially arranged in this order from the start.

When the core 121 in the CL0 acquires a command designating a virtual address in the MMIO area, the core accesses the CL1 through the NTB 126. The NTB 126 in the CL1 translates the virtual address in the MMIO area in the CL0 core virtual address space into the virtual address in the DRAM area in the CL1IO virtual address space.

In the DRAM area in the CL1IO virtual address space, a CL1MP0 protection area, a CL1MP0 system data area, a CL1MP0 user data area, a CL1 inter MP protection area, a CL1MP1 protection area, a CL1MP1 system data area, a CL1MP1 user data area, and a CL1 inter cluster protection area are serially arranged in this order from the start, as in the MMIO area in the CL0 core virtual address space. Thus, the address in the DRAM area in the CL1IO virtual address space is an address obtained by subtracting an offset of the MMIO start address from the address in the MMIO area in the CL0 core virtual address space.

After the NTB 126 in the CL translates the virtual address in the MMIO area into the virtual address in the DRAM area, the PCIe I/F 136 coupled to the NTB translates the virtual address in the CL1IO virtual address space into the physical address in the CL1 physical address space by using the IOMMU 122, and accesses the translated physical address.

In the DRAM area in the CL1 physical address space, a CL1MP0 system data area, a CL1MP0 user data area, a CL1MP1 system data area, and a CL1MP1 user data area are serially arranged in this order from the start. Each of the CL1MP0 system data area and the CL1MP1 system data area in the CL1 physical address space corresponds to the protection area in the CL1IO virtual address space. Thus, the core 121 and the ID devices in the CL0 cannot access the system data area in the CL1.

With the MMIO area, the command to the core 121 in a certain cluster 110 can designate a specific storage area in the memory 140 in the other-cluster by using the fixed virtual address, regardless of the change in the capacity of the memory 140 in the other-cluster.

The virtual address at the start of each area in the DRAM area is the same between two clusters 110, regardless of the capacity of the memory 140. Thus, the core 121 and the IC devices in the self-cluster can access the memory 140 in the other-cluster by designating the fixed virtual address, even when the capacity of the memory 140 in the other-cluster is different from the capacity of the memory 140 in the self-cluster.

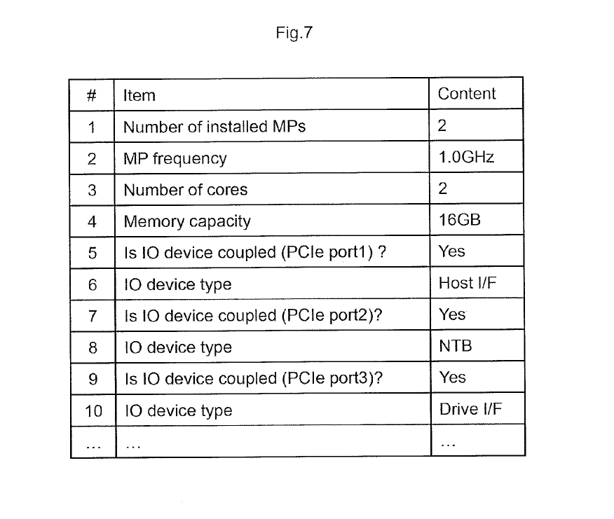

FIG. 7 shows hardware configuration information.

The hardware configuration information includes entries of data pieces related to the hardware configuration of the self-cluster. Apiece of information includes fields for a data number (#), an item name, and a content. The data number indicates an identifier of the data. The item name indicates the name of the data. For example, the item name includes: the number of installed MPs as the number of MPs 120 in the cluster; an MP frequency as an operation frequency of the MPs in the cluster; the number of cores as the number of cores 121 in the cluster; a memory capacity as the total capacity of the memories 140 in the cluster; whether the IO devices are coupled to a PCIe port 1 (PCIe I/F 138) in the cluster; the type of IO devices (coupled IO devices) coupled to the port; whether the IO devices are coupled to a PCIe port 2 (PCIe I/F 136) in the cluster; the type of IO devices (coupled IO devices) coupled to the port; whether the IO devices are coupled to a PCIe port 3 (PCIe I/F 137) in the cluster; the type of IO devices (coupled IO devices) coupled to the port; and the like. The content indicates the content of the data. For example, the content of the number of installed MPs is two and the content of the memory capacity is 16 GB.

With the hardware configuration information stored in the memory 140 and the like, the core 121 can refer to information, such as the number of installed MPs and the memory capacity of the self-cluster, required for Generating the core translation table and the IO translation table.

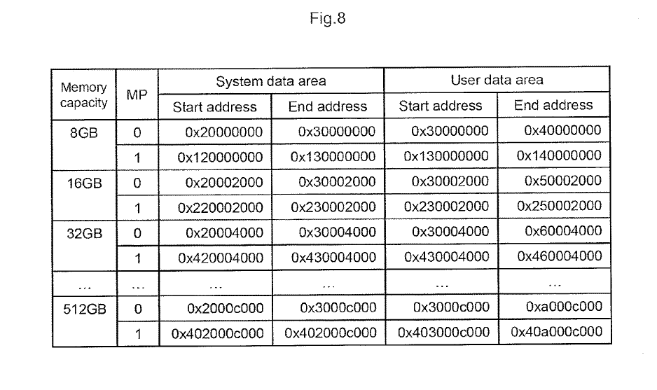

FIG. 8 shows a physical address table.

The physical address table includes entries corresponding to the memory capacity in the cluster and the identifiers of the MPs in the cluster. The cluster memory capacity is the total memory capacity in the cluster, and indicates the value of the memory capacity that the cluster can have. An entry corresponding to one cluster memory capacity and one MP includes fields for a cluster memory capacity (memory/cluster), an MP number (MP), a system data area range, and a user data area range. The MP number is an identifier indicating the MP, and indicates MP0 or MP1. The system data area range indicates the start address and the end address of the system data area in the MP in the physical address space. The user data area range indicates the start address and the end address of the user data area of the MP in the physical address space.

For example, the core 121 determines the start address of the system data area as the start address of the control data area, and calculates the start address of the start address by adding the predetermined size of the control data area to the start address of the control data area.

As described above, the relationship between the total capacity of the memory 140 in the cluster 110 and the start physical address of each area is determined in advance. Thus, the core 121 can determine the start physical address of each area in accordance with the capacity of the memory 140, and generate the core translation table and the TO translation table.

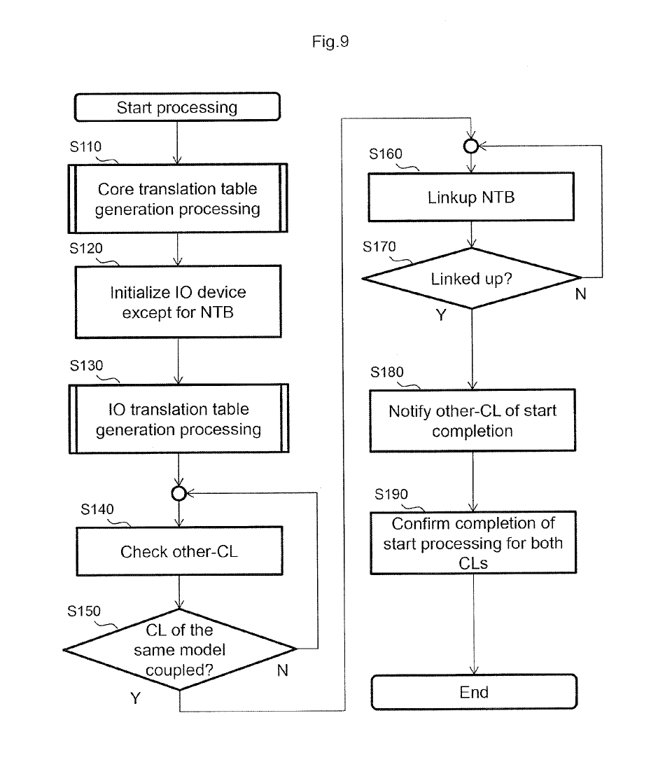

FIG. 9 shows processing of starting the cluster 110.

The administrator of the cluster 110 starts the cluster after changing the capacity of the memory 140 in the cluster, by expanding the memory 140 in the cluster for example.

In S110, the core 121 executes core translation table generation processing.

Then, in S120, the core 121 initializes the IO devices except for the NTB 126.

Then, in S130, the core 121 executes IO translation table generation processing described later.

Then, in S140, the core 121 acquires information on a model and a connection state of the other-cluster. Then, in S150, the core 121 determines whether the other-cluster of the same model as the self-cluster is coupled to the self-cluster.

When the core 121 determines that the cluster of the same model is not coupled to the self-cluster in S150 (N), the core 121 moves the processing back to S140.

When the core 121 determines that the cluster of the same model is coupled to the self-cluster in S150 (Y), the core 121 attempts to link up the NTB0 and the NTB1 in S160. Then, in S170, the core 121 determines whether the NTB0 and the NTB1 have been linked up.

When the core 121 determines that the NTB0 and the NTB1 have not been linked up in S170 (N), the core 121 moves the processing back to S160.

When the core 121 determines that the NTB0 and the NTB1 have been linked up in S170 (Y), the core 121 notifies the other-cluster of the completion of the starting in S180. Then, in S190, the core 121 checks that the starting processing for both clusters has been completed, and terminates the flow.

With the starting processing described above, the core translation table and the IO translation table can be generated after the capacity of the memory 140 changes.

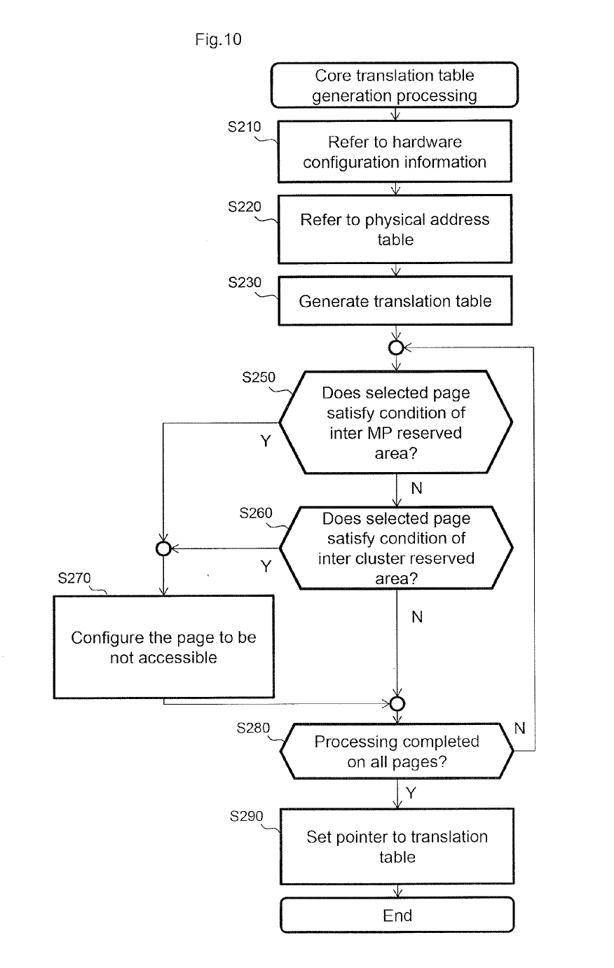

FIG. 10 shows core translation table generation processing.

In S210, the core 121 refers to the hardware configuration information and acquires the information on the memory capacity of the memory 140 and the number of MPs. Then, in S220, the core 121 refers to the physical address table. Then, in S230, the core 121 generates the core translation table based on the base table for the translation table, the memory capacity, and the physical address table, and configures the items other than the access rights. In the base table for the translation table, the MP1 start address is configured as the virtual address of the first page of the control data area of the MP1.

Then, in S250, the core 121 selects an unselected page from the core translation table and determines whether the page satisfies a condition of the inter MP reserved area. To satisfy the condition of the inter MP reserved area, the virtual address of the page needs to be larger than the end address of the MP0 user data area and smaller than the start address of the MP1 system data area.

When the core 121 determines that the page satisfies the condition of the inter MP reserved area in S250 (Y), the core 121 configures the page to be not accessible in S270, and the processing proceeds to S280. Here, the core 121 configures Read inhibit, Write inhibit, and Execute inhibit in the access rights of the page.

When the core 121 determines that the page does not satisfy the condition of the inter MP reserved area in S250 (N), the core 121 determines whether the page satisfies a condition of the inter cluster reserved area in S260. To satisfy the condition of the inter cluster reserved area, the virtual address of the page needs to be larger than the end address of the MP1 user data area.

When the core 121 determines that the page satisfies the condition of the inter cluster reserved area in S260 (Y), the processing by the core 121 proceeds to S270. When the core 121 determines that the page does not satisfy the condition of the inter cluster reserved area in S260 (N), the core 121 determines whether the processing has been completed on all the pages in the core translation table in S280.

When the core 121 determines that the processing has not been completed on all the pages in S280 (N), the core 121 moves the processing back to S250.

When the core 121 determines that the processing has been completed on all the pages in S280 (Y), the core 121 sets a pointer to the core translation table in an MSR (Model Specific Register) of the core 121 to activate the translation of the virtual address in S290, and terminates this flow.

With the core translation table generation processing described above, the core 121 can generate the core translation table in accordance with the capacity of the memory 140. The core 121 can configure the inter MP reserved area between the end address of the user data area of the first MP and the MP1 start address.

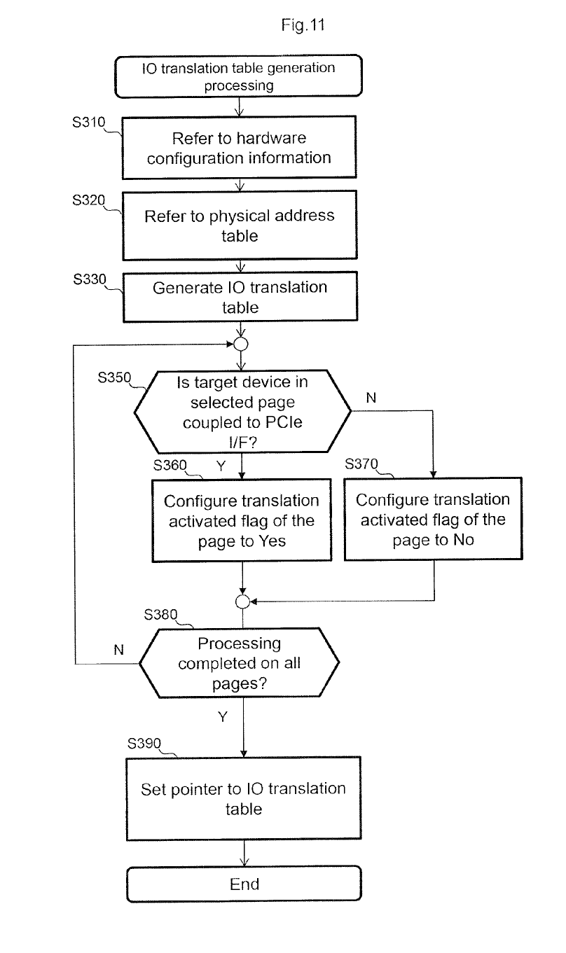

FIG. 11 shows IO translation table generation processing.

In S310, the core 121 refers to the hardware configuration information, and acquires the information on the memory capacity, the number of MPs, and the coupled IO devices. Then, in S320, the core 121 refers to the physical address table. Then, in S330, the core 121 generates the IO translation table based on the base table for the IO translation table, the memory capacity, and the physical address table, and configures the items other than the translation active flag. In the base table for the IO translation table, the MP1 start address is configured as the virtual address of the first page of the control data area of the MP1, and the IO device is configured as the target device of each page.

Then, in S350, the core 121 selects an unselected page from the IO translation table, and determines whether the target device of the page is coupled to the PCIe port.

When the core 121 determines that the target device is coupled to the PCIe port in S350 (Y), the core 121 configures a value of the translation active flag of the page in the IO translation table to “Yes” in S360, and the processing proceeds to S380.

When the core 121 determines that the target device is not coupled to the PCIe port in S350 (N), the core 121 configures a value of the translation active flag of the page in the IO translation table to “No” in S370, and the processing proceeds to S380.

In S380, the core 121 determines whether the processing has been completed on all the pages in the IO translation table.

When the core 121 determines that the processing has not been completed on all the pages in S380 (N), the processing by the core 121 returns to S350.

When the core 121 determines that the processing has been completed on all the pages in S380 (Y), the core 121 sets a pointer to the IO translation table in the register of the IOMMU 122 in the self-MP, and thus activates the translation of the virtual address by the IOMMU 122 in S390, and this flow is terminated.

Through the IO translation table generation processing, the core 121 can generate the IO translation table in accordance with the capacity of the memory 140 in the self-cluster. The core 121 can activate the address translation of the page corresponding to the coupled IO devices.

Front-end write processing in a computer system is described below.

In the front-end write processing, the host computer 300 transmits a write command and user data to the storage controller 100, and the user data is written to the memories 140 of two clusters 110.

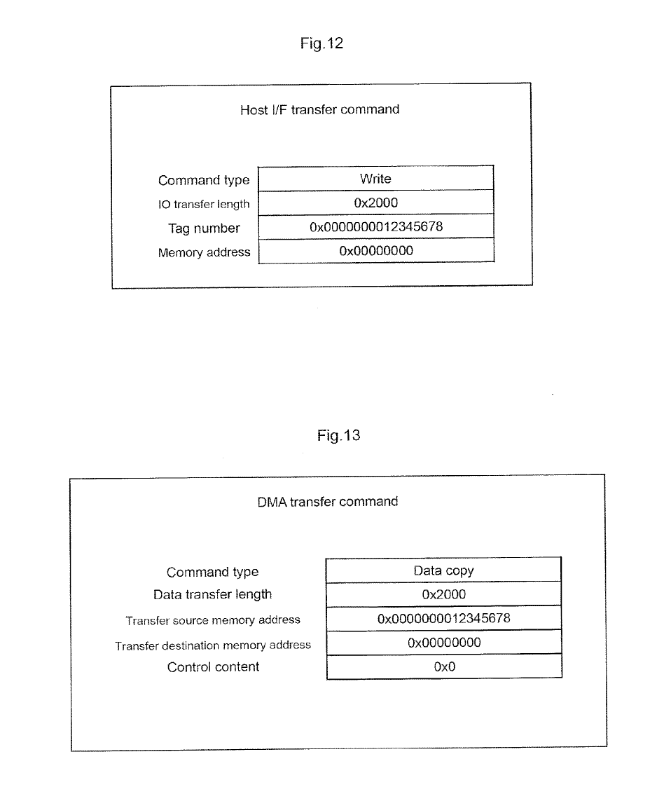

FIG. 12 shows parameters in a host I/F transfer command.

The core 121 generates the host I/F transfer command and writes the command to the storage area corresponding to the host I/F 160 in the memory 140, and thus instructs (commands) the host I/F 160 to transfer data. The host I/F transfer command includes fields for a command type, an IO transfer length, a tag number, and a memory address. The command type indicates the type of the command, and indicates read or write for example. The figure shows a case where the command type is write. In this case, the host I/F transfer command instructs the transferring from the host I/F 160 to the memory 140. The IO transfer length indicates the length of data transferred between the host I/F 160 and the memory 140. The tag number indicates an identifier provided to the transferred data. The memory address is a virtual address indicating the storage area of the memory 140. When the command type is write, the memory address indicates the storage area as the transfer destination. When the command type is read, the host I/F transfer command instructs the transferring from the memory 140 to the host I/F 160, and the memory address indicates the storage area as the transfer source.

FIG. 13 shows parameters in a DMA transfer command.

The core 121 generates the DMA transfer command, and writes the command to the storage area corresponding to the DMA 125 in the memory 140, and thus commands the DMA 125 to transfer data. The DMA transfer command includes fields for a command type, a data transfer length, a transfer source memory address, a transfer destination memory address, and a control content. The command type indicates the type of the command, and indicates data copy or parity generation for example. The figure shows a case where the command type is data copy. The data transfer length indicates the length of the data transferred from the DMA 125. The transfer source memory address is a virtual address indicating the storage area of the memory 140 of the transfer source. The transfer destination memory address is a virtual address indicating the storage area of the memory 140 of the transfer destination. The control content indicates the content of control executed by the DMA 125. Each of the transfer source memory address and the transfer destination memory address may be a virtual address in the DRAM area indicating the memory 140 in the self-cluster, or may be a virtual address in the MMIO area indicating the memory 140 in the other-cluster.

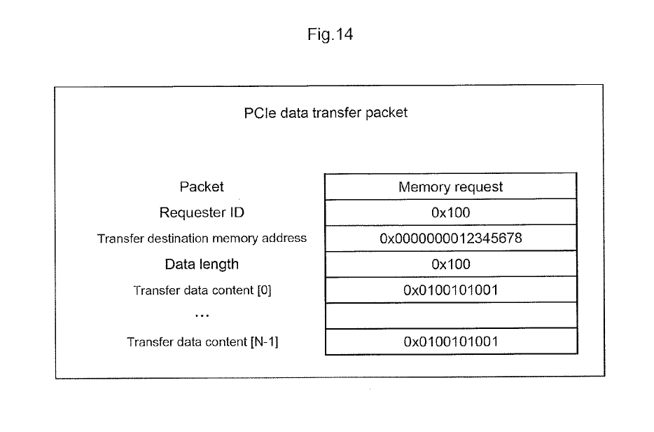

FIG. 14 shows parameters in a PCIe data transfer packet.

The PCIe data transfer packet is a packet for data transfer through a PCIe bus. The PCIe data transfer packet includes fields for a packet type, a requester ID, a transfer destination memory address, a data length, and transfer destination data contents [0] to [N−1]. The packet type indicates the type of the packet, and indicates a memory request, a configuration, and a message for example. The requester ID is an identifier for identifying an IO device that has issued the packet. The transfer destination memory address is an address indicating the storage area as the transfer destination of the packet, and is represented by a virtual address or a physical address. The data length indicates the length of the subsequent data. The transfer destination data contents [0] to [N−1] indicate data contents of the packet.

The NTB 126 rewrites the requester ID in the PCIe data transfer packet from the other-cluster, and rewrites the MMIO area as the virtual address indicating the transfer destination memory address with the DRAM area. Furthermore, the PCIe/IF 136 coupled to the NTB 126 rewrites the virtual address indicating the transfer destination memory address with a physical address by using the IOMMU 122, and executes transferring to the physical address.

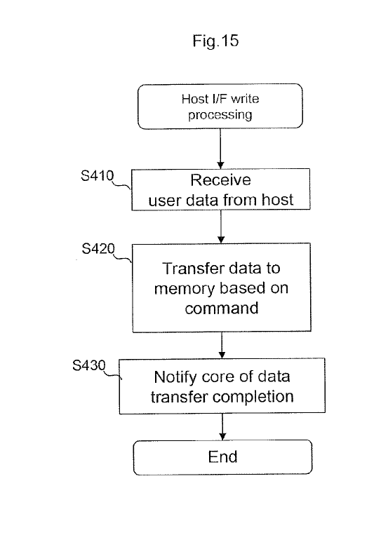

FIG. 15 shows host I/F write processing.

When the start processing is terminated, the host I/F 160 transmits information indicating that preparation for reception has been completed to the coupled host computer 300. Then, upon receiving a write command from the host computer, the host I/F notifies the core 121 in the self-MP of the write command. The core generates a host I/F transfer command and instructs the host I/F to read the host I/F transfer command. Thus, the host I/F starts the host I/F write processing.

In S410, the host I/F receives user data from the host computer. Then, in S420, the host I/F provides a CRC code to the user data, and generates and transfers a PCIe data transfer packet having the transfer destination memory address designated by the host I/F transfer command. Here, in use of the IOMMU, the PCIe I/F 138 coupled to the host I/F rewrites the virtual address indicating the transfer destination memory address of the PCIe data transfer packet with a physical address, and transfers the PCIe data transfer packet to the physical address.

Then, in S430, the host I/F notifies the core 121 in the self-MP of data transfer completion, and terminates the flow.

With the host I/F write processing, the host I/F 160 can transfer the user data received from the host computer 300 to the corresponding memory 140.

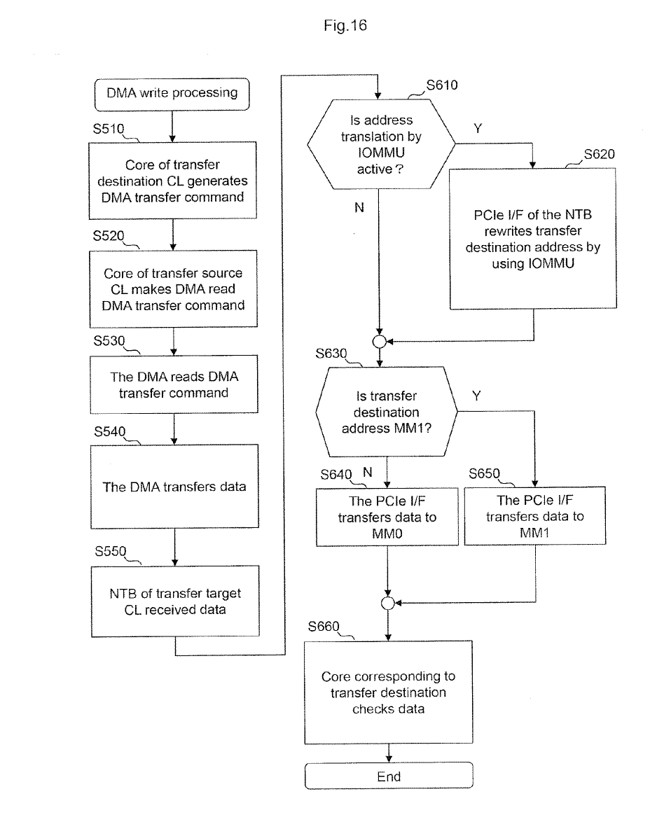

FIG. 16 shows DMA write processing.

In this embodiment, the two clusters 110 store duplicated write data in the memories 140. Thus, one of the clusters that has received and stored the write data transfers the write data to the other cluster. Here, the cluster 110 that has received the write command is referred to as a transfer source cluster. The MP 120 that has received the write command is referred to as a transfer source MP, and the other cluster is referred to as a transfer destination cluster.

In S510, the core 121 of the transfer source cluster that has received the notification indicating the data transfer completion through the host I/F write processing generates a DMA transfer command to the DMA 125 of the transfer source MP, and writes the command to the memory 140 coupled to the transfer source MP.

In S520, the core instructs the DMA to read the DMA transfer command.

In S530, the DMA reads the DMA transfer command. In S540, the DMA reads the user data in the transfer source memory address, and generates and transfers the PCIe data transfer packet to the transfer destination memory address designated with the DMA transfer command. Here, the PCIe I/F 135 coupled to the DMA translates a virtual address as the transfer source memory address into a physical address, by using the IOMMU 122. The DMA 125 reads the user data in the physical address, and transfers the read user data to the transfer destination memory address. The transfer destination memory address is in the NTB area in the MIO area, and thus the PCIe I/F 135 transfers the user data to the NTB 126 of the transfer source MP. The NTB 126 of the transfer source MP transfers the PCIe data transfer packet including the user data to the NTB 126 of the coupled transfer destination cluster. The transfer destination memory address in the PCIe data transfer packet indicates the user data area in the memory 140 in the other-cluster, and is a virtual address in the MMIO area.

In S550, the NTB 126 of the transfer destination cluster receives the PCIe data transfer packet transferred from the transfer source cluster. Here, the NTB rewrites the transfer destination memory address with an address in the DRAM area by subtracting the MMIO start address from the transfer destination memory address in the PCIe data transfer packet. Furthermore, the NTB rewrites the requester ID in the PCIe data transfer packet.

Then, in S610, the NTB determines whether the translation of the virtual address is active, based on the translation active flag corresponding to the virtual address of the transfer destination memory address in the IO translation table.

When the NTB determines that the translation of the virtual address is inactive in S610 (N), the NTB moves the processing to S630.

When the NTB determines that the translation of the virtual address is active in S610 (Y), in S620, the PCIe I/F 136 coupled to the NTB translates the virtual address as the transfer destination memory address in the PCIe data transfer packet into a physical address by using the IOMMU 122 of the self-MP, and thus rewrites the PCIe data transfer packet.

Then, in S630, the PCIe I/F determines whether the transfer destination memory address is the MM1 allocated area.

In S630, when the PCIe I/F determines that the transfer destination memory address is the MM0 allocated area (N), the PCIe I/F transfers the PCIe data transfer packet to the MM0 in S640, and moves the processing to S660.

In S630, when the PCIe I/F determines that the transfer destination memory address is the MM1 allocated area (Y), the PCIe I/F transfers the PCIe data transfer packet to the MM1 in S650, and moves the processing to S660.

Then, in S660, the core 121 of the MP 120 coupled to the memory 140 as the transfer destination reads the user data stored in the memory 140 as the transfer destination to execute CRC check to confirm that the user data has no error, and terminates the flow.

Through the DMA write processing described above, the DMA can transfer the user data stored in the memory 140 of the self-cluster to the memory 140 of the other-cluster, and thus the duplicated user data can be stored. The NTB 126 translates the virtual address in the MMIO area of the other-cluster into the virtual address in the DRAM area of the self-cluster, and thus the other-cluster can access the self-cluster. The PCIe I/F 136 coupled to the NTB 126 translates the virtual address in the DRAM area of the self-cluster indicating the transfer destination into a physical address by using the IOMMU 122. Thus, the other-cluster can access the memory 140 in the self-cluster.

A first specific example of the front-end write processing is described.

When the host I/F 160 of the CL0MP0 receives the user data from the host computer 300, the core 121 of the self-MP issues the host I/F transfer command to the host I/F. The host I/F adds a CRC (Cyclic Redundancy Check) code to the user data in accordance with the host I/F transfer command, and transfers the user data to the CL0MM0.

The core 121 of the CL0MP0 issues the DMA transfer command, instructing the transferring of the user data to the CL1MM0, to the DMA 125. The DMA transfers the user data from the CL0MM0 to the CL1MM0 in accordance with the DMA transfer command. Here, the user data is transferred from the NTB 126 of the CL0MP0 to the NTB 126 of the CL1MP0 through the PCIe bus, thus the user data is transferred to the CL0MM0 from the NTB 126 of the CL1MP0. The core 121 of the CL1MP0 reads the user data stored in the CL1MM0, and executes the CRC check.

In the first specific example described above, the user data from the host computer 300 coupled to the CL0MP0 is stored in the CL0MM0 and then is transferred to the CL1MM0 through the CL0MP0 and the CL1MP0. Thus, the duplicated user data is stored in the CL0MM0 and the CL1MM0.

A second specific example of the front-end write processing is described.

Operations executed up to the point where the user data is transferred to the CL0MM0 are the same as those in the first specific example. Then, the core 121 of the CL0MP0 issues the DMA transfer command, instructing the transferring of the user data, to the CL1MM1 to the DMA 125. The DMA transfers the user data from the CL0MM0 to the CL1MM1, in accordance with the DMA transfer command. Here, the user data is transferred from the NTB 126 of the CL0MP0 to the NTB 126 of the CL1MP0 through the PCIe bus, and thus the user data is transferred from the NTB 126 of the CL1MP0 to the CL1MM1 through the MP I/F 124 and the CL1MP1.

The core 121 of the CL1MP1 reads the user data stored in the CL1MM1 and executes the CRC check.

In the second specific example described above, the user data from the host computer 300 coupled to the CL0MP0 is stored in the CL0MM0, and then is transferred to the CL1MM0 through the CL0MP0, the CL1MP0, and the CL1MP1. Thus, the duplicated user data is stored in the CL0MM0 and the CL1MM1.

Through the front-end write processing described above, the storage controller 100 writes the user data from the host computer 300 to the memories 140 in the two clusters 110 so that the duplicated user data is stored. Thus, the reliability of the user data can be improved. Then, the storage controller 100 can write data stored in the memory 140 to the drives 210.

### Embodiment 2

A case where an extended virtual address different from the virtual address in Example 1 is used is described. In this embodiment, the difference from Embodiment 1 is described.

A command to the core 121 of this embodiment designates a storage area in the memory 140 with an extended virtual address. The core 121 generates a core extension translation table indicating association between extended virtual addresses and virtual addresses, and stores the table in the memory 140. The core 121 translates the designated extended virtual address into a virtual address by using the core extension translation table when accessing the memory 140, and translates the virtual address into a physical address by using the core translation table as in Embodiment 1.

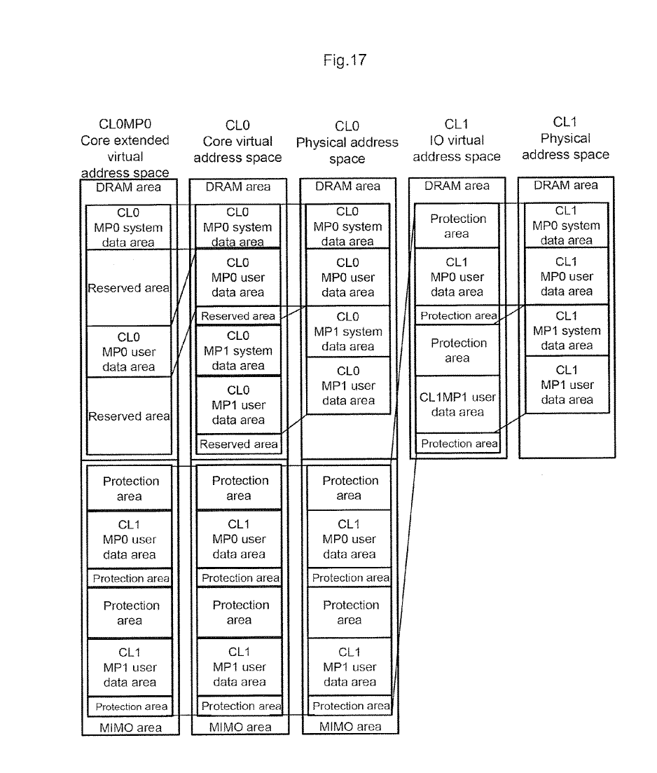

FIG. 17 shows relationship among address spaces of clusters in Embodiment 2.

The figure shows: a CL0MP0 core extended virtual address space as a space for the extended virtual address used by the core 121 of the MP0 of the CL0; the CL0 core virtual address space; the CL0 physical address space; the CL1IO virtual address space; and the CL1 physical address space, which are the same as the counterparts in Embodiment 1 except for the CL0MP0 core extended virtual address space.

In the DRAM area in the core extended virtual address space as a space for the extended virtual address used by a certain core 121, the self-MP system data area is arranged from the start, and the self-MP user data area starts from the user data area start address determined in advance. The user data area start address is equal to the total size of the system data areas of all the MPs in the self-cluster for example. The user data area start address may be larger than the total size of the system data areas of all the MPs in the self-cluster. The MMIO area in the core extended virtual address space is the same as the MMIO area in the core virtual address space. The system data reserved area is arranged between the system data area of the self-MP and the user data area of the self-MP. The user data reserved area is arranged between the user data area and the MMIO area of the self-MP. Thus, the system data area and the user data area of the other-MP are not arranged in the DRAM area in the core extended virtual address space.

Thus, in the DRAM area in the CL0MP0 core extended virtual address space, the CL0MP0 system data area is arranged from the start, and the CL0MP0 user data area starts from the user data area start address.

When the core 121 in the CL0 acquires a command that designates an extended virtual address in the DRAM area, the core translates the extended virtual address into a virtual address by using the core extension translation table, and coverts the translated virtual address into a physical address, and accesses the translated physical address.

When the core 121 in the CL0 acquires a command designating an extended virtual address in the MMIO area, the core accesses the CL1. The extended virtual address in the MMIO area is the same as the virtual address in the MMIO area. Thus, the operations thereafter are the same as those in a case of the command designating the virtual address in the MMIO area.

In the core extended virtual address space, the start address of the MP0 system data area may be configured to a system data address determined in advance, and the start address of the MP0 user data area may be configured to a user data address determined in advance. In this embodiment, the system data address is the start of the address space, and the user address is the user data area start address.

In a CL0MP0IO extended virtual address space, as a space for an extended virtual address used by the IO devices of the MP0 of the CL0, a CL0MP0 system data area, a system data reserved area, and a user data reserved area, in the CL0MP0 core extended virtual address space, are the protection areas that cannot be accessed by the IO devices. The CL0MP0 user data area in the CL0MP0IO extended virtual address space is the same as the CL0MP0 core extended virtual address space.

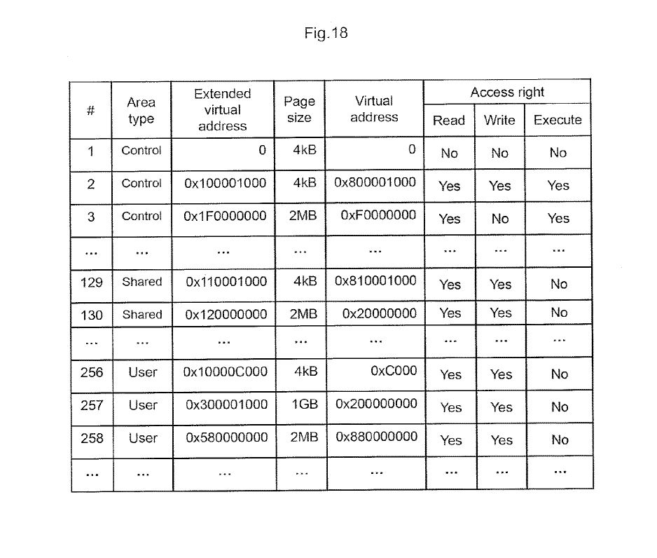

FIG. 18 shows a core extension translation table of Embodiment 2.

The core extension translation table is a page table including an entry for each page.

The entry for a page includes fields for a page number (#), an area type, an extended virtual address, a page size, a virtual address, and access rights. Each of the page number, the area type, the page size, and the access rights is the same as the corresponding field in the core translation table. The extended virtual address indicates the start address of the page in the core extended virtual address space. The virtual address indicates the start address of the page in the core virtual address space.

The core 121 can covert an extended virtual address into a virtual address by using the core extension translation table. Thus, the core 121 can access the memory 140 with the extended virtual address having the arrangement different from that of the virtual address designated.

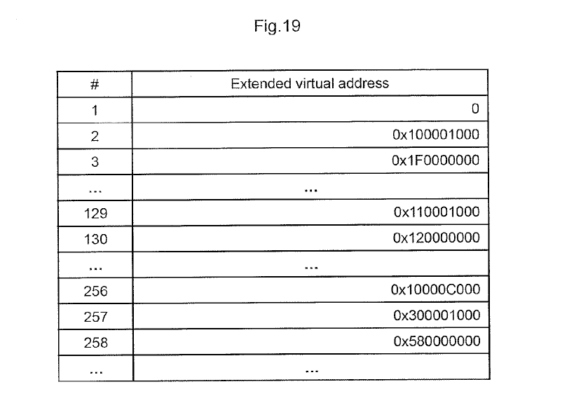

FIG. 19 shows an extended virtual address table.

The core extension translation table includes an entry for each page.

The entry for a page includes fields for a page number (#) and an extended virtual address. The page number indicates an identifier of the page. The extended virtual address indicates an extended virtual address determined for the page in advance.

The core 121 can generate the core extension translation table by using the extended virtual address table.

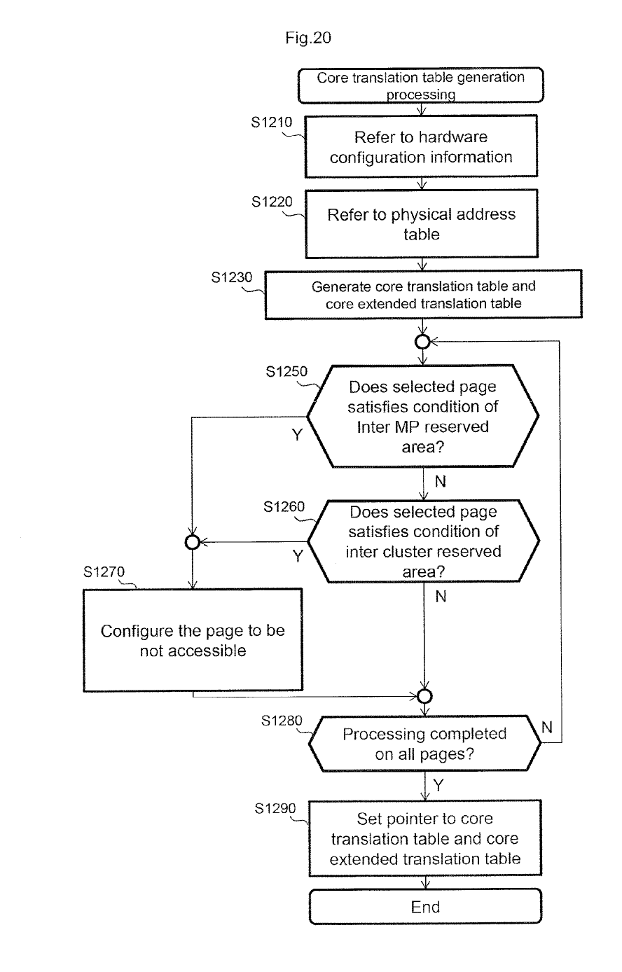

FIG. 20 shows core translation table generation processing in Embodiment 2.

Through the core translation table generation processing in this embodiment, the core 121 generates the core translation table and the core extension translation table.

S1210 and S1220 are respectively the same as S210 and S220 in the core translation table generation processing.

Then, in S1230, the core 121 generates the core translation table based on the base table for the core translation table, the memory capacity, and the physical address table, and configures the items other than the access rights. The core 121 further generates the core extension translation table based on the core translation table and the extended virtual address table, and configures the items other than the access rights.

S1250, S1260, and S1280 are the same as S250 in the core translation table generation processing.

When the core 121 determines that the page satisfies the condition of the inter MP reserved area in S1250 (Y), the core 121 configures the page to be not accessible in the core translation table and the core extension translation table in S1270, and moves the processing to S1280. The core 121 configures Read inhibit, Write inhibit, and Execute inhibit as the access rights of the page.

When the core 121 determines that the processing has been completed on all the pages in S1280 (Y), the core 121 sets the pointer to the core translation table and the core extension translation table to an MSR of the core 121 in S1290, to activate the translation of the extended virtual address and terminates this flow.

With the core translation table generation processing, the core translation table and the core extension translation table can be generated in accordance with the capacity of the memory 140.

### Embodiment 3

In IC translation table generation processing in this embodiment, the core 121 generates the IO translation table based on the core translation table.

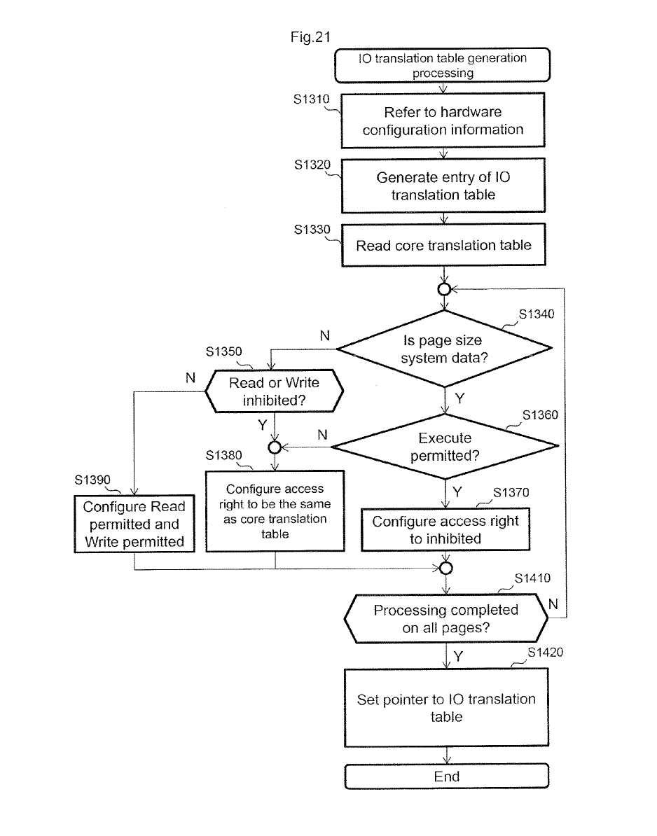

FIG. 21 shows IO translation table generation processing in Embodiment 3.

In S1310, the core 121 refers to the hardware configuration information to acquire information on the memory capacity, the number of MPs, and the coupled IO devices.

Then, in S1320, the core 121 generates the entry corresponding to the coupled IO devices in the IO translation table. Then, in S1330, the core 121 reads the core translation table.

In S1340, the core 121 selects an unselected page from the core translation table, and determines whether the page size is a predetermined system data page size, which is 4 kB for example.

When the core 121 determines that the page size is the system data Page size in S1340 (Y), the core 121 determines whether the Execute access right of the page in the core translation table is permitted (Yes) in S1360.

When the core 121 determines that the Execute access right of the page is permitted in S1360 (Y), the core 121 configures inhibit (Access Denied) to all the access rights of the page in the IO translation table in S1370, and moves the processing to S1410.

When the core 121 determines that the Execute access right of the page is inhibited in S1360 (N), the core 121 configures the access rights of the page in the IC translation table to be the same as the access rights of the page in the core translation table in S1380, and moves the processing to S1410.

When the core 121 determines that the page size is not the system data page size in S1340 (N), the core 121 determines whether the Read access right or the Write access right of the page in the core translation table is inhibited (No) in S1350.

When the core 121 determines that the Read access right or the Write access right of the page is inhibited in S1350 (Y), the core 121 moves the processing to S1380 described above.

When the core 121 determines that the Read access right and the Write access right of the page is permitted in S1350 (N), the core 121 configures the access rights of the page to Read permitted and Write permitted (R/W) in S1390, and moves the processing to S1410.

Then, in S1410, the core 121 determines whether the processing has been completed on all the pages in the IC translation table.

When the core 121 determines that the processing has not been completed on all the pages in S1410 (N), the core 121 moves the processing back to S1340.

When the core 121 determines that the processing has been completed on all the pages in S1410 (Y), the core 121 sets the pointer to the IO translation table in the register of the IOMMU 122 in the self-NP to activate the translation of the virtual address by the IOMMU 122 in S1420, and terminates the flow.

With the IO translation table generation processing described above, the core 121 can Generate the IO translation table based on the core translation table. Here, the core 121 can configure the access rights of each page in the IC translation table based on the core translation table.

The storage controller 100 may include one cluster 110. In such a case, the NTB 126 is omitted from the storage controller 100, and the MMIO area is omitted from the spaces of the physical address and the virtual address.

In the embodiments described above, the margin is arranged after the end address of the area with a variable capacity such as the user data area in the virtual address space, and then the area of the next type is arranged.

When the margin is arranged at least after the end address of the capacity variable data and then the next type of data is arranged, an effect of reducing the load due to the mapping change can be obtained even when the areas are arranged in the order different from that in the embodiments described above.

This invention is not limited to the embodiments described above, and can be modified in various ways without departing from the gist of the invention.

The terms for describing this invention are described. A first memory corresponds to the MM0 and the like. A second memory corresponds to the MM1 and the like. An offset corresponds to the MMIO start address and the like. First association information corresponds to the core translation table and the like. Second association information corresponds to the IO translation table and the like. Third association information corresponds to the core extension translation table and the like.

### REFERENCE SIGNS LIST

100 Storage controller
110 Cluster
120 MP
121 Core
122 IOMMU
123 Memory I/F
124 MP I/F
125 DMA
126 NTB
135, 136, 137, 138 PCIe I/F
150 Drive I/F
160 Host I/F
140 Memory
200 Drive box
210 Drive
300 Host computer

1. A storage system comprising:
a storage device; and
a control system coupled to the storage device, wherein
the control system includes two control-subsystems coupled to each other,
each of the two control-subsystems includes:
a plurality of control apparatuses coupled to each other; and
a plurality of memories coupled to the plurality of control apparatuses respectively,
each of the plurality of control apparatuses includes:
a processor; and
an input/output device coupled to the processor,
the input/output device includes a relay device coupled to a control apparatus in an other-control-subsystem of the two control-subsystems,
a space of a physical address indicating a storage area in a plurality of memories in a self-control-subsystem of the two control-subsystems and a space of a physical address indicating a storage area in a plurality of memories in the other-control-subsystem are associated with a space of a virtual address used by each of a processor and an input/output device in the self-control-subsystem, and
the relay device configured to, upon receiving data transferred from the other-control-subsystem to the self-control-subsystem, translate a virtual address indicating a transfer destination of the data designated by the other-control-subsystem into a virtual address in the self-control-subsystem based on an offset determined in advance, and transfer the data to the translated virtual address.

2. A storage system according to claim 1, wherein
each of the plurality of memories includes a system data area and a user data area,
access to the system data area by the input/output device is inhibited,
access to the user data area by the input/output device is permitted, and
in the space of the physical address in the self-control-subsystem, a system data area in a first memory of the plurality of memories, a user data area in the first memory, a system data area in a second memory of the plurality of memories, and a user data area in the second memory are serially arranged.

3. A storage system according to claim 2, wherein
in the space of the virtual address designated by the self-control-subsystem, a storage area of the plurality of memories in the self-control-subsystem starts at a predetermined self-control-subsystem address, and a storage area of the plurality of memories in the other-control-subsystem starts at a predetermined other-control-subsystem address after the storage area of the plurality of memories in the self-control-subsystem.

4. A storage system according to claim 3, wherein
in the space of the virtual address, the system data area and the user data area in the first memory start at a predetermined first system data address, and the system data area and the user data area in the second memory start at a predetermined second system data address after the user data area in the first memory.

5. A storage system according to claim 4, wherein
the processor configured to generate first association information which associates physical addresses of the system data area and the user data area in the self-control-subsystem with virtual addresses, and
the processor configured to, upon receiving a command designating a first virtual address indicating a storage area in the self-control-subsystem, translate the first virtual address into a first physical address based on the first association information, and access the first physical address.

6. A storage system according to claim 5, wherein
each of the plurality of control apparatuses includes a memory management device coupled to the processor and the input/output device,
the processor configured to generate second association information which associates physical addresses of the user data area in the self-control-subsystem with virtual addresses,
the memory management device configured to refer to the second association information, and
the input/output device configured to, upon receiving a command designating a second virtual address indicating the user data area in the self-control-subsystem, translate the second virtual address into a second physical address by using the memory management device, and access the second physical address.

7. A storage system according to claim 2, wherein
in each of the plurality of memories, the system data area includes a control data area and a shared data area,
access to the control data area by a processor in a control apparatus coupled to the other memory of the plurality of memories is inhibited,
access to the shared data area by a processor in the self-control-subsystem is permitted, and
in the space of the physical address, the control data area and the shared data area are serially arranged in the system data area.

8. A storage system according to claim 1, wherein
a sum of capacities of the plurality of memories in the self-control-subsystem is different from a sum of capacities of the plurality of memories in the other-control-subsystem.

9. A storage system according to claim 1, wherein
the processor configured to acquire physical address information indicating relationship between a sum of capacities of the plurality of memories in the self-control-subsystem and a physical address in the plurality of the memories in the self-control-subsystem, acquire memory capacity information indicating a sum of the capacities of the plurality of memories in the self-control-subsystem, and generate the association information based on the physical address information and the memory capacity information.

10. A storage system according to claim 6, wherein
the first association information includes information on an access right for each storage area in the plurality of memories in the self-control-subsystem, and
the processor configured to configure the information on the access right of a corresponding storage area to the second association information, based on the information on the access right for each storage area in the first association information.

11. A storage system according to claim 5, wherein
the processor configured to generate third association information which associates a virtual address with an extended virtual address which is a different virtual address,
in the space of the extended virtual address, the system data area in a local memory of the plurality of memories starts at a predetermined system data address, and the user data area in the local memory starts at a predetermined user data address after the system data area in the local memory, and
the processor configured to, upon receiving a command designating a first extended virtual address indicating a storage area in the self-control-subsystem, translate the first extended virtual address into the first virtual address based on the third association information, translate the first virtual address into a first physical address based on the first association information, and access the first physical address.

12. A storage system comprising:
a storage device; and
a control system coupled to the storage device, wherein
the control system includes:
a plurality of control apparatuses; and
a plurality of memories coupled to the plurality of control apparatuses respectively,
each of the plurality of control apparatuses includes:
a processor; and
an input/output device coupled to the processor,
each of the plurality of memories includes a system data area and a user data area, access from the input/output device to the system data area being inhibited, access from the input/output device to the user data area being permitted, and
in a space of a physical address indicating a storage area in the plurality of memories, a system data area in a first memory of the plurality of memories, a user data area in the first memory, a system data area in a second memory of the plurality of memories, and a user data area in the second memory are serially arranged.

13. A storage system according to claim 12, wherein
a space of a physical address indicating a storage area in the plurality of memories is associated with a space of a virtual address used by each of the processor and the input/output device, and
in the space of the virtual address, the system data area and the user data area in the first memory starts at a predetermined first system data address, and the system data area and the user data area in the second memory starts at a predetermined second system data address after the user data area in the first memory.

14. A storage system according to claim 13, wherein
the processor configured to generate first association information which associates physical addresses indicating storage areas in the plurality of memories with virtual addresses, and
the processor configured to, upon receiving a command designating a first virtual address indicating a storage area in the plurality of memories, translate the first virtual address into a first physical address based on the first association information, and access the first physical address.
